(19) United States
(12) Patent Application Publication
(10) Pub. No.: US 2020/0025588 A1
(43) Pub. Date: Jan. 23, 2020

(54) Magnetic Field Sensor

(71) Applicant: Hirtenberger Engineered Surfaces GmbH, Hirtenberg (AT)

(72) Inventors: Wolfgang Hansal, Markt Piesting (AT); Selma Hansal, Markt Piesting (AT); Rudolf Mann, Wien (AT)

(21) Appl. No.: 16/496,248

(22) PCT Filed: Mar. 20, 2018
(86) PCT No.: PCT/AT2018/050004

§ 371 Date: Sep. 20, 2019

(30) Foreign Application Priority Data
Mar. 20, 2017 (AT) A 50222/2017

(51) Int. Cl. G01D 5/20; G01L 1/12

(52) U.S. Cl. CPC G01D 5/20; G01L 1/122

(57) ABSTRACT

The invention relates to a magnetic field sensor (100, 100A, 100B) for components (200) having a preferably cylindrical, conical, prismatic main body (210) or having a free-form main body, wherein at least one first magnetic conductive track (110) and at least one second conductive track (120) are mounted on the main body (210 of the component (200), and the at least second conductive track (120) is arranged at a distance—preferably in the form of a separation layer (300)—from the at least first magnetic conductive track (110), wherein at least one exciter magnet is provided and a change in the magnetic flux due to a change in the distance (A) of the at least one first magnetic conductive track (110) from the at least second magnetic conductive track (120) is monitored.

The invention relates to a magnetic field sensor for components having a preferably cylindrical, conical, prismatic main body or having a free-form main body, wherein at least one first magnetic conductive track and at least one second conductive track are mounted on the main body of the component, and the at least second conductive track is arranged at a distance from the at least first magnetic conductive track, a method for manufacturing the magnetic field sensor as well as its use as pressure sensor and/or distance sensor.

Measuring physical quantities at components of e.g. vehicles and airplanes, machines or buildings is an essential aspect of their maintenance and operational monitoring. An important factor is the force acting on a component, the measurement of which provides important information on the load or the overall condition of the component.

The most commonly used method at present is the measurement of deformations and of the forces occurring in this case by means of strain gauges attached at respective points of the component. One major disadvantage of this system is that these strain gauges are adhesively attached to the component to be measured and that this adhesive attachment interferes with the transfer of measurement information and possibly distorts them. In addition, the strain gauge has to be electrically contacted in order to read out measurement information, and in case of metallic components it is necessary to completely isolate the electric measuring circuit from the component.

Consequently, methods have been made known in which the measurement of deformations of a component is conducted magnetically.

DE 10 2014 200 461 A1 thus describes an arrangement for measuring a force or a torque on a machine element with a permanent magnetization along a closed magnetization path. Here, a magnetic field sensor is provided, which monitors a change of the magnetic field. This arrangement is not suitable for all components because it requires a permanent magnetization of the components in at least a certain area. In addition, it is susceptible to errors caused by external magnetic and/or electric or electromagnetic influences.

DE 36 24 846 A1 describes a device for measuring mechanical stress without contact, in particular for measuring a torsion or bending force of a measured object. Here, two areas with a layer of magnetoelastic material are arranged on a shaft having a striated pattern formed under an angle of 45°. A change of this striated pattern due to mechanical strain on the shaft is monitored by means of a complicated evaluation circuit. A further magnetoelastic torque sensor can also be found in DE 103 31 128 A1.

The above arrangements are only partly or not at all suitable for monitoring deformation processes on a component or they have a complicated design that is not very suitable in practice.

In particular when monitoring tools of material machining apparatus, such as milling, turning or punching tools, or casting or injection molding tools, monitoring the forces acting on the respective tool and/or the position of the respective tool is helpful in order to avoid long and expensive downtimes of these machines due to defect tools. Likewise, maintenance intervals may be planned better based on the results obtained.

According to the invention, this object is solved by monitoring the magnetic flux in the at least one magnetic conductive track and a change in the distance between the at least one first magnetic conductive track and the at least second magnetic conductive track leads to a change of the magnetic flux.

The distance between the at least first magnetic conductive track and the at least second magnetic conductive track changes due to forces acting on the component to be monitored. This also changes the magnetic resistance between the at least two magnetic conductive tracks, which again changes the magnetic flux in the at least two magnetic conductive tracks. This change of the magnetic flux is thus an indicator of a force acting on the component and possibly of a deformation of the component to be monitored.

In the context of this disclosure, “magnetic conductive track” means an area on the component to be monitored having ferromagnetic properties. It may actually be sheet-shaped, however, may also be provided as a surface area or volume section of any form on the surface of or within the component.

Here, it is envisaged that the magnetic flux in the at least two magnetic conductive tracks is induced by at least one exciter magnet, which preferably is in direct contact with the magnetic conductive tracks. Alternatively, the at least one exciter magnet may also be external to the magnetic field sensor, e.g. as part of the component to be monitored or as additional element in the area of the component to be monitored.

This exciter magnet may be a permanent magnet, which is preferably also manufactured by means of electroplating. For this, a hard magnetic alloy is deposited, or permanent magnetic particles may be intercalated in a non-magnetic matrix. Alternatively, the exciter magnet may also be an electromagnet.

The inventive magnetic field sensor is preferably arranged directly on the component to be monitored, with a change of the distance between the two magnetic conductive tracks being monitored.

In case the inventive magnetic field sensor serves to monitor a component consisting of a soft magnetic material, this variant comprises a magnetic barrier layer of a non-magnetic material in order to avoid a distortion of the magnetic field and thus a distortion in the measurement of the magnetic flux.

The inventive magnetic field sensor preferably comprises at least one measuring device for monitoring the magnetic fluxes within the at least two conductive tracks. This results in an integral measuring sensor without the requirement of any additional external measuring units.

It is particularly preferred that the at least one measuring device is provided in the form of a measuring chip with at least one, preferably two internal magnetic measuring sections, wherein the measuring chip is preferably arranged on an electrically isolating carrier, e.g. plastic, ceramics, glass, sapphire or mica. This measuring chip evaluates magnetic flux changes and transmits the data to an (external) evaluation unit.

In a particularly preferred embodiment of the invention it is envisaged that the at least two magnetic conductive tracks and the at least one measuring device form a magnetic measuring circuit. Here, it is particularly preferred that the at least one exciter magnet is also part of this magnetic measuring circuit. Alternatively, the at least on exciter magnet may be arranged externally to the magnetic field sensor.

In error-prone environments, it may be necessary to compensate external effects such as stray fields or temperature variations, which affect the magnetic flux independently from the effect of a force. For this purpose, a second magnetic circuit is provided, namely a magnetic compensation circuit with preferably at least one further exciter magnet. Adaptation of the magnetic resistance of the compensation circuit may optionally be achieved by manipulating the permeability of the magnetic conductor during manufacturing, namely the deposition by e.g. varying the impulse pattern used for depositing, by geometric variations such as of the layer thickness and/or the layer width, by introducing an additional interruption of the magnetic conductor of the compensation circuit at a suitable position or by a combination of these measures.

The at least one measuring device, in particular a measuring chip, preferably connects the two magnetic circuits, namely the at least one measuring circuit and the at least one compensation circuit, via a Wheatstone bridge. This arrangement allows measuring even smallest changes of a magnetic flux.

The inventive magnetic field sensor is particularly suitable for the use as pressure sensor and/or distance sensor, and here in particularly in tools, tool insertions, closing mechanisms and pressure bodies, in particular of material machining apparatus, such as milling, turning or punching tools, or casting or injection molding tools.

The object is additionally solved by means of a manufacturing method for an inventive magnetic field sensor by means of which a first magnetic conductive track as well as at least a second magnetic conductive track are applied on a substrate, preferably on a component to be monitored, by means of electroplating over a stretch and at a distance from each other.

Here, a soft magnetic alloy, e.g. a nickel-iron alloy with an optimized composition, is applied on a preferably non-magnetic, optionally masked component by means of electroplating. It is particularly envisaged that the at least one first magnetic conductive track and the at least one second magnetic conductive track are separated by a non-magnetic separation layer, which may also be applied by electroplating.

In case the base onto which the magnetic field sensor is applied is magnetic itself, e.g. made of steel or cast iron, a non-magnetic layer has to be applied on the base material before the conductive tracks are applied. This non-magnetic lacer is—just like the above separation layer—for example also an electroplated layer made of copper, tin, zinc, or an alloy of two or more of these elements or a non-magnetic alloy of iron metals and phosphorus. This fully metallic design provides an optimum connection between the sensors and the component without e.g. an additional adhesive layer for attaching the sensor to the component to be measured that might affect the measuring results.

Manufacturing of exciter magnets, which are especially suitable for the inventive magnetic field sensor, by means of electroplating may be achieved in different ways.

In one variant, a permanent magnetic alloy selected from a group consisting of alloys such as cobalt-nickel-phosphorus, cobalt-nickel-manganese-phosphorus, cobalt-nickel-rhenium-phosphorus, iron-platinum, cobalt-platinum and bismuth-manganese is deposited on the substrate or component by means of electroplating.

Alternatively, permanent magnetic microparticles or nanoparticles are incorporated into a non-magnetic, metallic matrix during electroplating on the substrate, in particular the component. Candidate particles here include all hard magnetic materials as well as hard magnetic alloys in a suitable form, such as nanowires, powders such as ferrite, chromium dioxide, iron oxide, neodymium-iron-boron powder or cobalt-samarium powder. These particles may either be used in their pure form or after a suitable chemical surface modification, e.g. with siloxanes. The chemical modification of the surface of the particles serves, on the one hand, to control the incorporation rate of the particles in the electroplated layer, on the other hand it may increase the chemical stability against the electrolyte used for depositing.

Preferably, deposition of the permanent magnetic layer occurs in a magnetic layer applied externally, which orientates the particles in their magnetization direction and thus increases the field strength of the electroplated permanent magnet.

In the following, the invention will be described in detail by means of non-limiting exemplary embodiments and their respective figures. Herein,

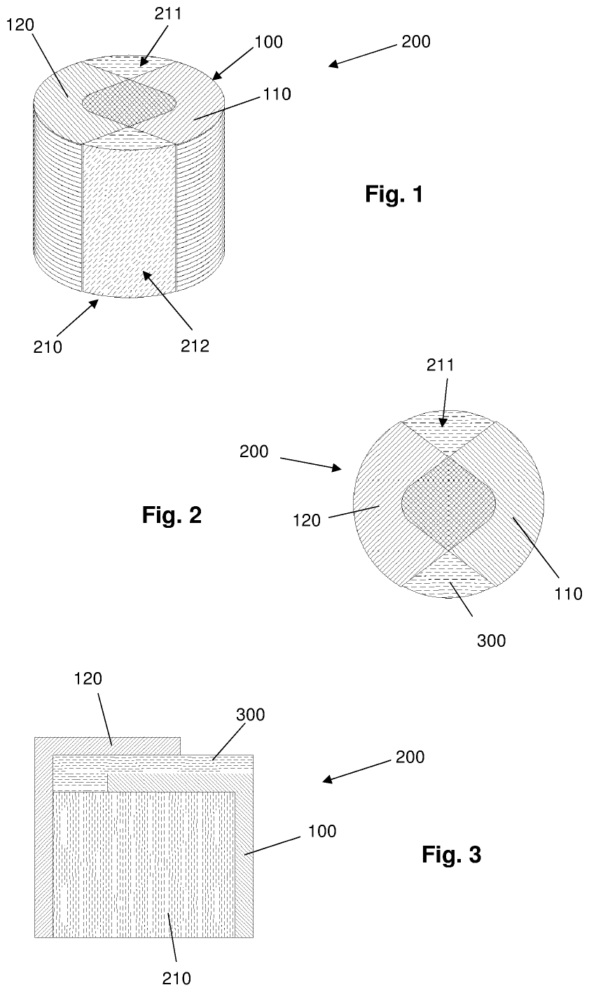

FIG. 1 shows a perspective view of an inventive pressure sensor in a schematic representation;

FIG. 2 shows a top view of the pressure sensor of FIG. 1;

FIG. 3 shows a cross-section of the pressure sensor of FIG. 1;

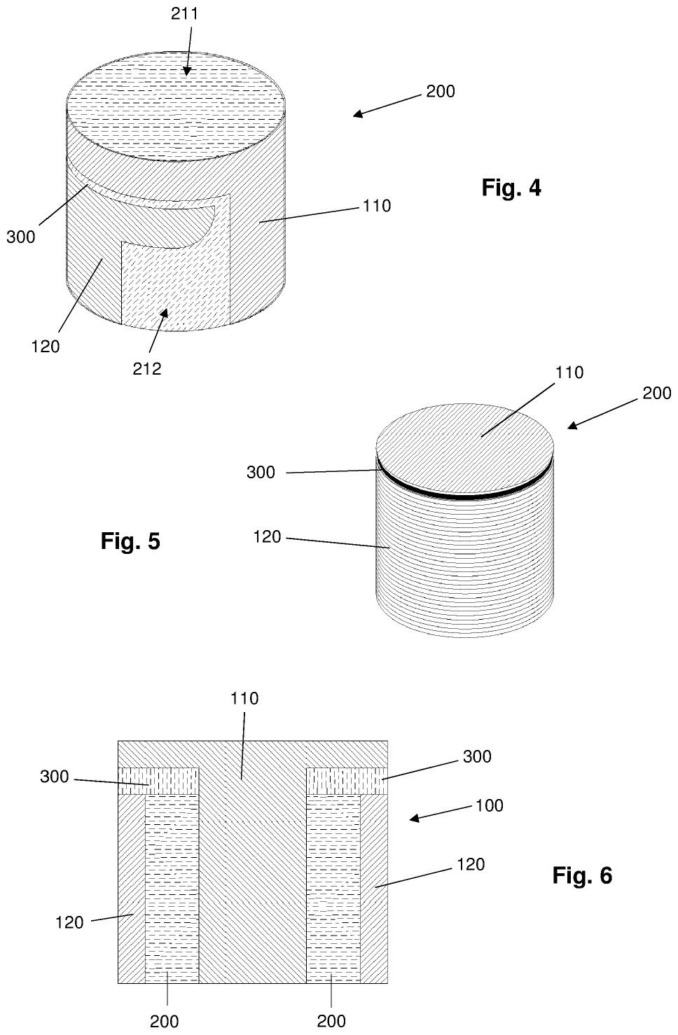

FIG. 4 shows a second embodiment of a pressure sensor in a perspective view;

FIG. 5 shows a third embodiment of a pressure sensor in a perspective view;

FIG. 6 shows a cross-sectional view of the pressure sensor of FIG. 5;

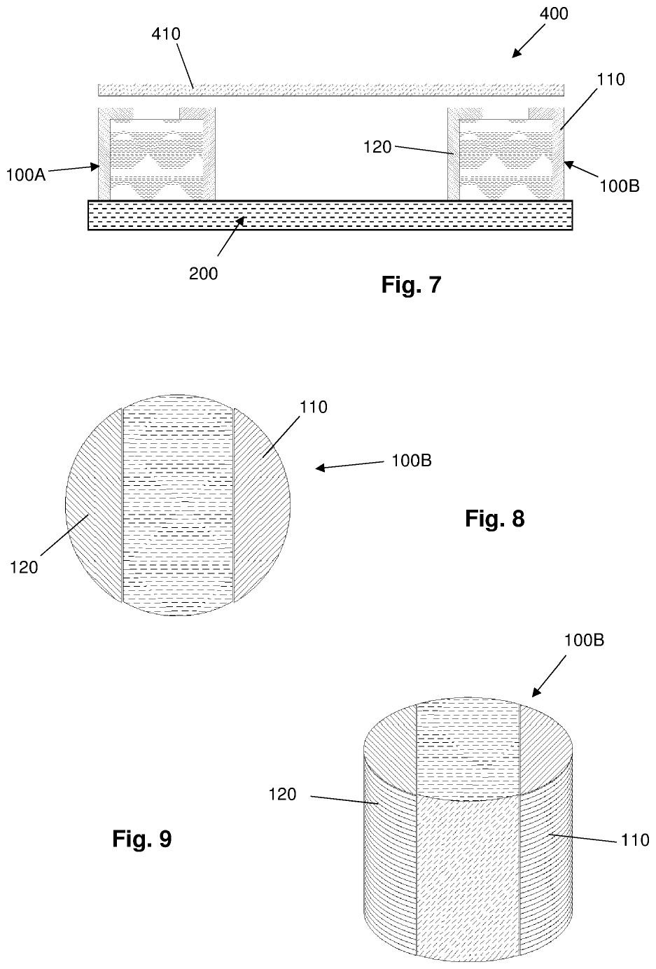

FIG. 7 shows an arrangement of two inventive magnetic field sensors for measuring a distance;

FIG. 8 shows a magnetic field sensor from the arrangement of FIG. 7 in a top view;

FIG. 9 shows a magnetic field sensor from the arrangement of FIG. 7 in a perspective view; and

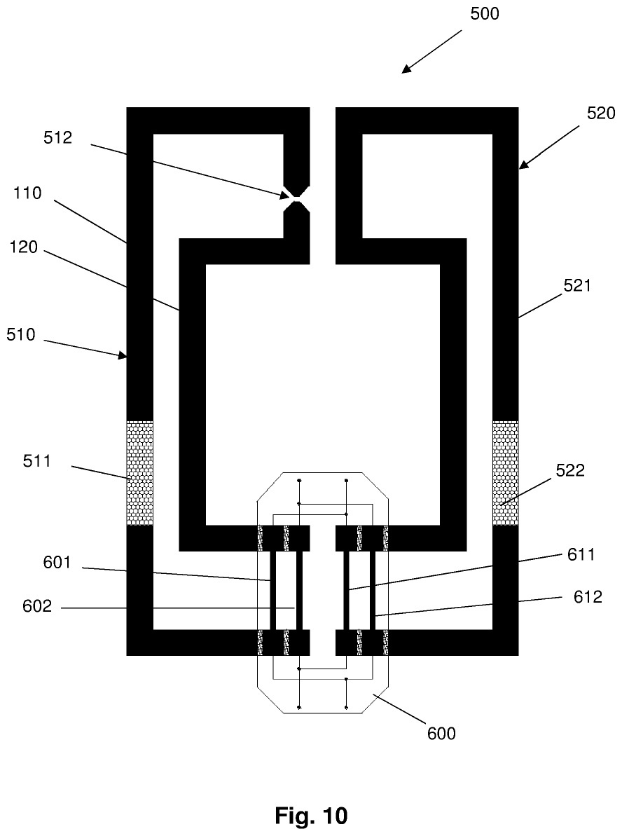

FIG. 10 shows a schematic representation of the measuring device for the inventive pressure sensor.

FIG. 1 shows an inventive magnetic field sensor 100 on a component 200 with a substantially cylindrical main body 210. In this variant embodiment, component 200 is made of a non-magnetic metal. Here, the magnetic field sensor 100 acts as pressure sensor and consists of a first magnetic conductive track 110, which partly covers the end face 211 as well as the coat 212 of component 200. A second magnetic conductive track 120 also covers parts of the end face 211 as well as of the coat 212 of component 200.

Here, the first magnetic conductive track 110 and the second magnetic conductive track 120 overlap, wherein the two conductive tracks 110, 120 are magnetically separated from each other by a layer of a non-magnetic material 300. The first magnetic conductive track 110 and the second magnetic conductive track 120 as well as the non-magnetic separation layer 300 are particularly applied to component 200 by means of electroplating methods.

If a force acts on the end face 211 of component 200, separation layer 300 is compressed and the first magnetic conductive track 110 approaches the second magnetic conductive track 120 so that the distance and thus the magnetic field induced between the two conductive tracks 110, 120 changes. This magnetic field change may be detected by a corresponding measuring device and subsequently evaluated by means of a suitable evaluation device.

In the variant of the inventive magnetic field sensor 100 on a substantially cylindrical component 200 shown in FIG. 4, the first magnetic conductive track 110 and the second magnetic conductive track 120 are exclusively arranged on the coat surface 212 of component 200. For example, if a pressure force acts on end face 211, the extension of separation surface 300 between the first magnetic conductive track 110 and the second magnetic conductive track 120 and thus again the magnetic field between the two magnetic conductive tracks 110, 120 change.

In a third embodiment of the inventive magnetic field sensors 100, the first magnetic conductive track 110 is arranged on a component 200 on the end face 211 of component 200, while the second magnetic conductive track 120 covers the coat surface 212 of component 200 (see FIG. 5).

In the cross-sectional view of FIG. 6 it may be seen that the first magnetic conductive track 110 does not only cover the end face 211 of component 200, but also projects into component 200. Thus, component 200 may, for example, have a boring into which part of the first magnetic conductive track 110 is introduced. The second magnetic conductive track 120 encloses component 200 along its coat surface 212 and is separated from the first magnetic conductive track 110 via a separation layer 300 in the area of the end face 211 of component 200. If a force acts on end face 211 and thus on the first conductive track 110 of component 200, separation layer 300 is again compressed so that the magnetic flux between the first magnetic conductive track 110 and the second magnetic conductive track 120 changes. This magnetic field change may again be detected and evaluated.

FIG. 7 shows an arrangement 400, wherein inventive magnetic field sensors 100A, 100B are arranged on a component 200 at a distance from each other. These magnetic field sensors 100A, 100B have the purpose of monitoring the distance between component 200 and a counterpart 410. In this arrangement 400, counterpart 410 is also magnetic and induces a magnetic field in the two conductive tracks 110, 120 of the respective magnetic field sensors 100A, 100B. As long as the respective distance between counterpart 410 and the two magnetic field sensors 100A, 100B remains equal, i.e. component 200 is oriented substantially parallel with counterpart 410, the magnetic flux in the respective magnetic field sensors 100A, 100B is equal. However, if the distance to one of the two magnetic field sensors 100A, 100B changes, i.e. component 200 is not oriented parallel with counterpart 410 anymore, the magnetic fluxes in the respective magnetic field sensors 100A, 100B are different, and these magnetic field differences may be detected and evaluated.

A magnetic field sensor 100B used in this context may be seen in FIGS. 8 and 9. Again, areas of the coat surface or of the end face of magnetic field sensor 100B are separated from the first magnetic conductive track 110 and the second magnetic conductive track 120 and covered.

In this way, the correct position of component 200, e.g. the correct position of a tool with regard to its tool holder, may be monitored. This arrangement 400 may be used either without contact, as described above, i.e. as distance sensor, or with contact between component 200 or the magnetic field sensors 100A, 100B and counterpart 410. In the second case, the magnetic field sensors 100A, 100B act as pressure sensors monitoring the surface or contact pressure between component 200 and counterpart 410 or exact parallelism between the two parts.

It may also be envisaged that for example the end faces of the magnetic field sensors 100A, 100B are provided with a top layer (not shown) that acts as a shield against counterpart 410. Wear of this top layer again changes the magnetic field of the magnetic field sensors 100A, 100B so that the top layer acts as wear indicator.

For the sake of simplicity, the at least one exciter magnet and the measuring and evaluation unit are not shown in the figures described above. For example, a measuring unit as described in Austrian Patent Application A 50057/2017 to the applicant may be used.

FIG. 10 schematically shows such an arrangement 500.

Here, a first magnetic measuring circuit 510 is provided with the first magnetic conductive track 110 and the second magnetic conductive track 120, wherein the conductive tracks 110, 120 are shown as simple linear tracks in this representation, irrespective of their actual shape. The two magnetic conductors 110, 120 are—as described in the above examples—arranged at a distance from each other, which is symbolized by an interruption 512 in this representation. The magnetic measuring circuit 510 has an exciter magnet 511 with which a constant magnetic field is created in the first magnetic measuring circuit 510.

In order to minimize influences, in particular magnetic and/or electromagnetic influences from the surroundings, the evaluation unit 500 of this embodiment additionally comprises a second magnetic measuring circuit 520 as a compensation measuring circuit with a magnetic conductive track 521, which circuit has a second exciter magnet 522.

If the distance between the two conductive tracks 110, 120 and thus the distance in the interruption 512 changes due to the effect of an external force, the magnetic flux in the conductive tracks 110, 120 changes as well. For this, the magnetic fluxes of the two magnetically active measuring circuits 510, 520 are measured against each other via a measuring chip 600.

The ends of the two magnetic conductive tracks 110, 120 of the first magnetic measuring circuit 510 are coupled with two magnetic inputs of measuring chip 600. Between these two inputs, two magnetic measuring sections 601, 602 are provided, which serve for monitoring interruption 512 in the first magnetic measuring circuit 510.

For the compensation circuit 520, another two magnetic inputs are provided on measuring chip 600, which are again connected via two measuring sections 610, 611.

Lastly, terminals for supplying electrical energy to the measuring chip 600 and signal outputs for evaluating the measuring signals obtained are provided.

It is understood that the present invention is not limited to the above exemplary embodiments. In particular, it should be mentioned that the creation of magnetic conductive tracts may be achieved in different ways and that it is not limited to only two magnetic conductive tracts. In addition, the component to be monitored may have any shape.

1-15. (canceled)

16. A magnetic field sensor for a component having a main body, the magnetic field sensor comprising:
at least one first magnetic conductive track and at least one second conductive track mounted on the main body of the component, wherein the at least one second conductive track is arranged at a distance from the at least one first magnetic conductive track; and
at least one exciter magnet, wherein a change in a magnetic flux due to a change in a distance of the at least one first magnetic conductive track from the at least on second magnetic conductive track is monitored.

17. The magnetic field sensor of claim 16, wherein the at least one exciter magnet is a permanent magnet.

18. The magnetic field sensor of claim 16, further comprising a magnetic barrier layer of a non-magnetic material.

19. The magnetic field sensor of claim 16, further comprising at least one measuring device for monitoring the magnetic flux.

20. The magnetic field sensor of claim 19, wherein the at least one measuring device is formed as a measuring chip with at least one measuring section, wherein the measuring chip is arranged on an electrically isolating carrier.

21. The magnetic field sensor of claim 19, wherein the at least one first magnetic conductive track and the at least second magnetic conductive track and the at least one measuring device form a magnetic measuring circuit.

22. The magnetic field sensor of claim 21, wherein the at least one exciter magnet is formed as part of the magnetic measuring circuit.

23. The magnetic field sensor of claim 16, wherein the least second conductive track is arranged at a distance in the form of a separation layer.

24. The magnetic field sensor of claim 19, wherein the at least one measuring device is formed as a measuring chip with two or four internal magnetic measuring sections.

25. A method for manufacturing a magnetic field sensor according to claim 16, the method comprising:
applying the at least one first magnetic conductive track on a component to be monitored by electroplating; and
applying the at least one second magnetic conductive track on the component to be monitored at a distance from the first magnetic conductive track.

26. The manufacturing method of claim 25, wherein the at least one first magnetic conductive track and the at least one second magnetic conductive track are made of a soft magnetic alloy.

27. The method of claim 25, further comprising applying a non-magnetic layer on the component to be monitored before the at least one first conductive track is applied.

28. The method of any one of the claim 25, further comprising applying at least one exciter magnet on the component by electroplating.

29. The method of claim 28, further comprising depositing a permanent magnetic alloy, which is selected from a group consisting of cobalt-nickel-phosphorus, cobalt-nickel-manganese-phosphorus, cobalt-nickel-rhenium-phosphorus, iron-platinum, cobalt-platinum and bismuth-manganese, on the substrate by means of electroplating.

30. The method of claim 29, wherein permanent magnetic microparticles or nanoparticles are incorporated into a non-magnetic, metallic matrix during electroplating on the substrate.

31. The method of claim 27, wherein the non-magnetic layer that is applied on the base material is selected from a group consisting of copper, tin, zinc or an alloy of two or more of these elements or a non-magnetic alloy of iron metals with phosphorus.
